(19) United States
(12) Patent Application Publication
(10) Pub. No.: US 2026/0219899 A1
(43) Pub. Date: Jul. 30, 2026

(54) GENERATING INTERFACE FOR COMMUNICATION ELEMENTS

(71) Applicant: Walmart Apollo, LLC, Bentonville, AR (US)

(72) Inventors: Abhinav Prakash, Milpitas, CA (US); Akash Daxeshkumar Patel, Sunnyvale, CA (US); Keerthi Gopalakrishnan, San Jose, CA (US); Hongyao Huang, Newark, CA (US); Ishan Karanwal, San Francisco, CA (US); Archana Venkatachalapathy, Santa Clara, CA (US); Yokila Arora, San Jose, CA (US); Sushant Kumar, San Jose, CA (US); Kannan Achan, Saratoga, CA (US); Topojoy Biswas, Pleasanton, CA (US)

(21) Appl. No.: 19/040,050

(22) Filed: Jan. 29, 2025

(51) Int. Cl. G06F 9/451; H04L 67/306

(52) U.S. Cl. CPC G06F 9/451; H04L 67/306

(57) ABSTRACT

Example implementations relate to communication element selection in a network environment. In an example, a plurality of user features is received and input data derived from the plurality of user features is processed using a window logic and provided to an attention-based machine learning model. A plurality of communication elements is provided to the attention-based machine learning model, which assigns one or more weights to each of the plurality of communication elements for a subsequent time period based on the plurality of user features obtained from a preceding time period. A score for each of the plurality of communication elements based on the one or more weights for each of the plurality of communication elements is calculated and an interface including a communication element of the plurality of communication elements having a highest calculated score is generated.

### TECHNICAL FIELD

This application relates generally to automated communication element selection, and more particularly, to automated communication element selection in network environments.

### BACKGROUND

Network interfaces, such as social media, fitness, news, logistics, delivery and e-commerce interfaces, can provide different benefits or interactions based on a user's enrollment in certain programs. For example, enrollment in a loyalty or other membership program can enable a user to access portions of a user interface inaccessible to non-members, perform modified actions not available to non-members, and/or provide additional benefits supplemental to interactions performed through a user interface.

### BRIEF DESCRIPTION OF THE DRAWINGS

Various examples will be described below with reference to the following figures.

FIG. 1 is a block diagram of an example communication element selection system in accordance with some embodiments.

FIG. 2 is a schematic diagram of different example components of the communication element selection system in accordance with some embodiments.

FIG. 3 is a block diagram of an example rolling window approach for handling data in accordance with some embodiments.

FIG. 4 is a block diagram showing an example system for selecting one or more communication elements in accordance with some embodiments.

FIG. 5 is a schematic table for different example grouping of the communication elements in accordance with some embodiments.

FIG. 6 shows example user interfaces generated based on an output of the communication element selection system in accordance with some embodiments.

FIG. 7 is a flowchart illustrating an example communication element selection method in accordance with some embodiments.

FIG. 8 is an example machine-readable storage medium in accordance with some embodiments.

FIG. 9 depicts a block diagram of an example communication element selection computing device in accordance with some embodiments.

### DETAILED DESCRIPTION

The disclosed systems and methods provide a communication element selection process that utilizes an attention-based machine learning model to learn representations of various user features so that a relevant benefit of an enrollment program associated with a network environment, which may include a diverse range of benefits, may be accurately presented to a user. For example, the network environment may include a platform on which users may disclose and/or receive information (e.g., fitness, news, logistics, delivery, or other types of information), interact via social media, list items for sale, and/or buy items offered by sellers.

In various embodiments, a system including a processor and a non-transitory memory storing instructions is disclosed. The instructions, when executed, cause the processor to receive a plurality of user features and provide input data that is derived from the plurality of user features and processed using a rolling window logic and divided into a plurality of time windows to an attention-based machine learning model. The instructions further cause the processor to provide a plurality of communication elements to the attention-based machine learning model. The attention-based machine learning model assigns one or more weights to each of the plurality of communication elements for a subsequent time period based on the plurality of user features obtained from a preceding time period within a time window of the plurality of time windows. The instructions further cause the processor to calculate a score for each of the plurality of communication elements based on the one or more weights for each of the plurality of communication elements. Each score is indicative of a probability of interaction with a corresponding communication element based on the plurality of user features. The instructions further cause the processor to generate an interface including a communication element of the plurality of communication elements having a highest calculated score.

In various embodiments, a computer-implemented method is disclosed. The computer-implemented method includes steps of receiving a plurality of user features and providing input data that is derived from the plurality of user features and processed using a rolling window logic and divided into a plurality of time windows to an attention-based machine learning model. The computer-implemented method further includes a step of providing a plurality of communication elements to the attention-based machine learning model. The attention-based machine learning model assigns one or more weights to each of the plurality of communication elements for a subsequent time period based on the plurality of user features obtained from a preceding time period within a time window of the plurality of time windows. The computer-implemented method further includes a step of calculating a score for each of the plurality of communication elements based on the one or more weights for each of the plurality of communication elements. Each score is indicative of a probability of interaction with a corresponding communication element based on the plurality of user features. The computer-implemented method further includes a step of generating an interface including a communication element of the plurality of communication elements having a highest calculated score.

In various embodiments, a non-transitory computer-readable medium having instructions stored thereon is disclosed. The instructions, when executed by at least one processor, cause at least one device to perform operations including receiving a plurality of user features and providing input data that is derived from the plurality of user features and processed using a rolling window logic and divided into a plurality of time windows to an attention-based machine learning model. The instructions further cause the at least one device to perform operations including providing a plurality of communication elements to the attention-based machine learning model. The attention-based machine learning model assigns one or more weights to each of the plurality of communication elements for a subsequent time period based on the plurality of user features obtained from a preceding time period within a time window of the plurality of time windows. The instructions further cause the at least one device to perform operations including calculating a score for each of the plurality of communication elements based on the one or more weights for each of the plurality of communication elements. Each score is indicative of a probability of interaction with a corresponding communication element based on the plurality of user features. The instructions further cause the at least one device to perform operations including generating an interface including a communication element of the plurality of communication elements having a highest calculated score.

This description of the example embodiments is intended to be read in connection with the accompanying drawings that are to be considered part of the entire written description. Terms concerning data connections, coupling and the like, such as “connected,” “interconnected,” and/or “in signal communication with” refer to a relationship wherein systems or elements are electrically connected (e.g., wired, wireless) to one another, either directly or indirectly, through intervening systems, unless expressly described otherwise. The term “operatively coupled” is such a coupling or connection that enables the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

Furthermore, in the following, various embodiments are described with respect to methods and systems for communication element selection. In various embodiments, the methods and systems described herein are capable of using a machine learning model to learn representations of various user features associated with a user of a network environment. The network environment may offer an enrollment program that provides one or more benefits to the user. The ability to compute a score indicative of a probability of interaction between the user and a communication element associated with an underlying benefit of the enrollment program may enable the communication element selection system to be responsive to the unique preferences and/or behavior of the user by delivering individualized recommendations associated with one or more benefits of the enrollment program to the user (e.g., by presenting one or more communication elements associated with the one or more benefits to the user), improving the relevance and utilization of the enrollment program for the user, and may help improve user experience and/or ease of performing various interactions (e.g., transactions) in the network environment.

The enrollment program, as described herein in some embodiments, may provide benefits that have very distinctive characteristics. For example, the enrollment program may include benefits that are first party (e.g., benefits that related to network activities in the network environment) and benefits that are fulfilled by a third party (e.g., benefits that are related to activities outside of the network environment). The enrollment program may include benefits that relate to different domains (e.g., cost-saving features related to interactions in the network environment, features enabling faster interactions with the network environment, additional services provided by the network environment, and/or services provided by other third parties), have different usage patterns (e.g., a one-time sign-up, or repeated usage) and/or have different user appeal (e.g., fuel discount features may not appeal to users with electric vehicles, and/or travel related offerings may not appeal to users of some age groups). These benefits of the enrollment program may also be referred hereinafter as “heterogeneous benefits,” in view of their diverse and distinct nature.

A communication element selection system, as described herein in some embodiments, may function as a recommendation system for selecting a communication element corresponding to a benefit of the enrollment program that would be presented to a user. In some instances, the user may not have been aware of a particular benefit and had not started utilizing that benefit of the enrollment program, and/or the benefit may have been newly introduced to the enrollment program. Selecting a communication element from a wide range of heterogeneous benefits may be challenging due to the varied nature of data (e.g., associated with various aspects of the benefits) such a selection system may have to handle. A consolidated framework for selecting a communication element (e.g., corresponding to a respective underlying benefit) across a range of heterogeneous benefits of the enrollment program may help to reduce operational complexities by avoiding the use of cumbersome systems that utilize separate algorithms for each benefit type, and may thereby help to reduce a likelihood of a user having a fragmented user experience in the network environment with respect to the different benefits of the enrollment program. Instead of using one machine learning model for calculating usage probabilities associated with a free shipping benefit of the enrollment program and another machine learning model for calculating usage probabilities associated with a travel benefit of the enrollment program, the disclosed communication element selection system is able to calculate usage probabilities for all benefits in the enrollment program in a single integrated model and the highest ranked communication elements (e.g., having highest usage probabilities) are presented to the user. For example, a machine learning model may include its own set of biases. Using an integrated machine learning model for ranking (e.g., instead of using multiple different learning models, each having its own set of biases) may help address the issue of the presence of multiple sets of biases which may not have the same calibration (e.g., and may not be easily accounted for).

Reducing the system complexity may also simplify the architecture and maintenance of the communication element selection system by eliminating the use of multiple specialized algorithms. For example, the use of a consolidated communication element selection system also enables the communication element selection system to adapt and accommodate updates to the enrollment program (e.g., updated with newly added benefits and/or removing previously offered benefits).

The communication element selection systems and methods described herein, in some embodiments, may also be able to capture how a user's interest in one benefit may influence their likelihood of using another benefit of the enrollment program and may improve the relevance and consistency of the selected communication element. For example, a user's affinity for a benefit that relates to streaming services may provide some indication about a user's likelihood of using a benefit that relates to shipping. As another example, a user's affinity for a benefit that relates to free shipping may provide some indication about a user's likelihood of using a benefit that relates to travel. Although specific embodiments discussed herein include benefits related to interactions with a network environment, it will be appreciated that any suitable benefits for interaction with any suitable platform can be represented within communication elements and identified as a recommended communication element according to the disclosed systems and methods.

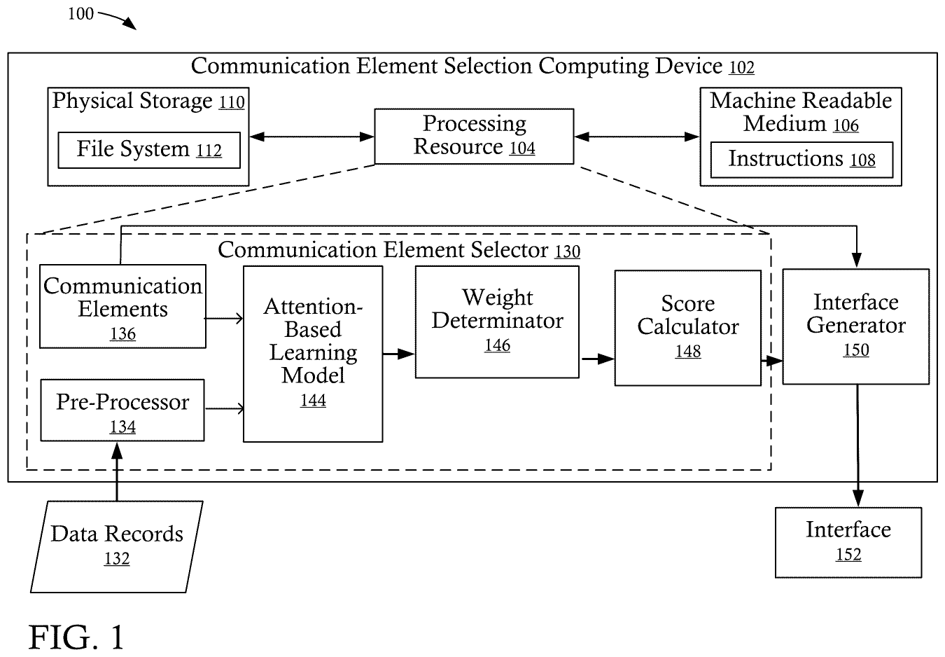

FIG. 1 depicts an example system 100 that implements communication element selection, in accordance with some embodiments. System 100 includes a communication element selection computing device 102 that selects a communication element to be displayed to a user. The communication element selection computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The communication element selection computing device 102 includes a non-transitory machine-readable medium 106 that may include one or more of a random-access memory (RAM), read-only memory (ROM), electrically erasable programmable read-only memory (EEPROM), flash memory, hard disk, and/or any other suitable memory resource.

In some embodiments, the communication element selection computing device 102 selects a communication element associated with a benefit of an enrollment program to be presented (e.g., displayed on a user interface) to a user. For example, the user may not be aware of a benefit in the enrollment program that may be relevant (e.g., highly relevant) to the user, and the communication element selection computing device 102 identifies one or more such communication elements and presents the communication elements to the user. The processing resource 104 may execute instructions 108 (i.e., programming or software code) stored on machine readable medium 106 to perform functions of the communication element selection computing device 102, such as receiving a plurality of user features and providing input data that is derived from the plurality of user features and processed using a rolling window logic and divided into a plurality of time windows to an attention-based machine learning model, providing a plurality of communication elements to the attention-based machine learning model, calculating a score for each of the plurality of communication elements based on the one or more weights for each of the plurality of communication elements, and generating an interface including a communication element of the plurality of communication elements having a highest calculated score. The attention-based machine learning model assigns one or more weights to each of the plurality of communication elements for a subsequent time period based on the plurality of user features obtained from a preceding time period within a time window of the plurality of time windows. Each score is indicative of a probability of interaction with a corresponding communication element based on the plurality of user features. For example, the assignment of weights is a part of the model training for the attention-based machine learning model. During the model training, the weights provide different levels of attention to different historical user data point based on user groupings described below. The instructions 108 may include instructions for implementing one or more models. In some embodiments, and as will be described further herein below, the communication element selection computing device 102 may execute one or more models, processes, or algorithms, such as a machine learning model, deep learning model, statistical model, etc., (e.g., implemented as machine readable instructions), to select a communication element.

The communication element selection computing device 102 may also include other hardware components, such as physical storage 110. Physical storage 110 may include any physical storage device, such as a hard disk drive, a solid-state drive, or the like, or a plurality of such storage devices (e.g., an array of disks), and may be locally attached (e.g., installed) in the communication element selection computing device 102. In some implementations, physical storage 110 may be accessed as a block storage device.

In some cases, the communication element selection computing device 102 may also include a local file system 112 that may be implemented as a layer on top of the physical storage 110. For example, an operating system may be executing on the communication element selection computing device 102 (by virtue of the processing resource 104 executing certain instructions 108 related to the operating system) and the operating system may provide a file system 112 to store data on the physical storage 110.

The communication element selection computing device 102 may be in communication with one or more additional devices over one or more network channels. For example, in various embodiments, the communication element selection computing device 102 may be in communication with a web server, a cloud-based engine including one or more processing devices that may be provisioned for use, a database, a workstation, and/or any other suitable system or device. The communication element selection computing device 102 may similarly be in communication, either directly or indirectly, with one or more user computing devices operatively coupled over the network. The other computing systems may be similar to the communication element selection computing device 102 and may each include at least a processing resource and a machine-readable medium.

In some embodiments, the communication element selection computing device 102, such as the processing resource 104, includes a communication element selector 130 that implements an attention-based learning model 144. Data records 132, which may include network activities of a user, attributes associated with user interactions with one or more benefits programs, and/or information related to the user, are processed through a pre-processor 134 and are provided as input data to the attention-based learning model 144. For example, the communication element selection computing device 102 receives a plurality of user features (e.g., via the data records 132) and provides input data that is derived from the plurality of user features and processed using a rolling window logic and divided into a plurality of time windows, as described in greater details below, to the attention-based learning model 144. A collection of communication elements 136 corresponding to various benefits is also provided to the attention-based learning model 144. For example, the communication element selection computing device 102 provides the collection 136 of communication elements to the attention-based learning model 144. The output of the attention-based learning model 144 is provided to a weight determinator 146 to generate respective weight for one or more of the benefits associated with the enrollment program. For example, in some embodiments, the attention-based machine learning model 144 alone or in conjunction with the weight determinator 146, assigns one or more weights to each of the plurality of communication elements in the collection 136 of communication elements for a subsequent time period based on the plurality of user features obtained from a preceding time period within a time window of the plurality of time windows. For example, the assignment of weights is a part of the model training for the attention-based machine learning model. During the model training, the weights provide different levels of attention to different historical user data point based on user groupings, which are described below.

In some embodiments, as explained in detail below, the communication element selector 130 is enabled to direct the attention-based learning model 144 to pay more attention to communication elements associated with benefits that are more relevant to the user by assigning a higher dynamic weight and/or attention score (e.g., via the weight determinator 146) to those relevant benefits. By assigning an appropriate weight or attention score to a respective benefit, a corresponding score is calculated for each benefit. A communication element corresponding to the benefit having the highest calculated score may be presented to the user (e.g., as a recommended benefit to the user). In some embodiments, the output of the weight determinator 146 is provided to a score calculator 148 to generate an output indicative of the selected communication element. For example, in some embodiments, the communication element selection computing device 102 calculates a score, via the score calculator 148, for each of the plurality of communication elements in the collection of communication elements based on the one or more weights for each of the plurality of communication elements (e.g., calculated based on the weight determinator 146). Each score is indicative of a probability of interaction with a corresponding communication element based on the plurality of user features. The output of the communication element selector 130 and the corresponding communication element from the collection 136 of communication elements are provided to an interface generator 150 to generate an interface 152 that is provided to the user. For example, in some embodiments, the communication element selection computing device 102 generates an interface 152 that includes a communication element from the collection of communication elements 136 having a highest calculated score (e.g., as computed by the score calculator 148).

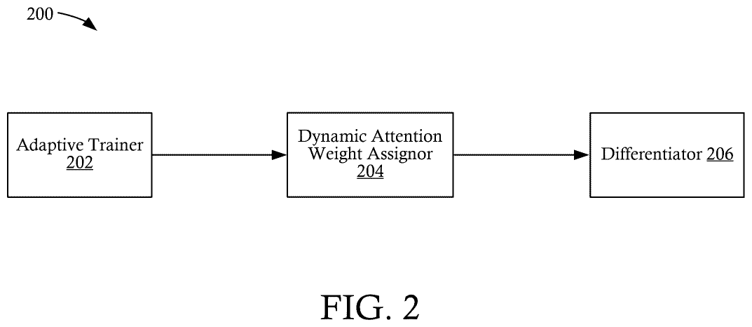

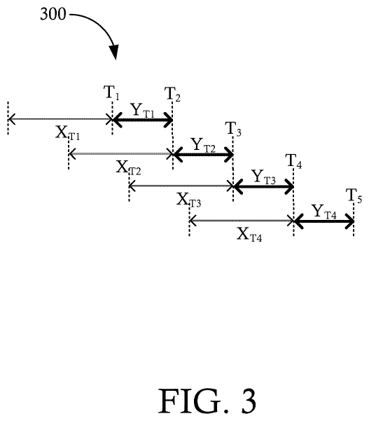

FIG. 2 is a schematic diagram of the different components of an example communication element selection system 200 in accordance with some embodiments. The system 200 may be implemented by a computing device, such as the communication element selection computing device 102 illustrated in FIG. 1. In some embodiments, the communication element selection system 200 selects a communication element associated with a benefit of an enrollment program to be presented (e.g., displayed on a user interface) to a user by using an adaptive trainer 202 to train an attention-based deep learning model using a large number of features derived from relevant data sources. The system 200 implements a communication element selection process that selects a communication element based on a determined likelihood a user would interact with an underlying benefit (e.g., of an enrollment program) that is associated with the communication element. The system 200 includes an adaptive trainer 202 that utilizes a rolling window logic, described in detail below with reference to FIG. 3, to train a machine learning model (e.g., the attention-based learning model 144 of FIG. 1) using a number (e.g., more than a hundred features, more than a hundred fifty features, and/or other number of features) of user features (e.g., derived from the data records 132). In some embodiments, the adaptive trainer 202 may be implemented by the communication element selector 130 (e.g., by the pre-processor 134) illustrated in FIG. 1. The system 200 includes a dynamic attention weight assignor 204 that assigns dynamic attention weights to each communication element associated with a respective benefit of the enrollment program (e.g., each communication element in the collection 136 of communication elements in FIG. 1) based on the user's feature representation (e.g., derived from the data records 132, and/or processed via the adaptive trainer 202 and using an output from the adaptive trainer 202). The system 200 includes a differentiator 206 that distinguishes benefits that are used once (e.g., a benefit that relates to streaming services may involve a one-time sign up process to access the streaming services) from benefits that have repeated usage (e.g., free delivery from a store, free shipping with no minimum purchase, fuel discount features, scan-and-go features enabling faster interactions with the network environment, and/or early access to items within a database of the network environment).

FIG. 3 is a diagram of an example rolling window approach 300 for handling data (e.g., data records 132 illustrated in FIG. 1) in accordance with some embodiments. A rolling window approach 300 is used, for example in the adaptive trainer 202 illustrated in FIG. 2, to process user features (e.g., derived from the data records 132 illustrated in FIG. 1) and for training a machine learning model (e.g., the attention-based machine learning model 144 of FIG. 1). For example, input data that is derived from various user features is processed using a rolling window logic and divided into a plurality of time windows before it is provided to an attention-based machine learning model.

Data from a first time period (e.g., ending at time T₁) are used to extract information about a user feature X associated with the first time period, denoted as X_{T1}. In some embodiments, the first time period is coextensive with the length of a time window (e.g., three months, two months, or another length of time). In some embodiments, the first time period may be a portion of the length of a time window (e.g., the first time period is one month within a three-month time window, two weeks within a three-month time window, or another length of time). The user feature X_{T1} determined from the data associated with the first time period ending at time T₁ is used to predict a label for a benefit Y in a time period following (e.g., immediately following) time T₁ that ends at time T₂, denoted as Y_{T1}. In some embodiments, predicting a label for a benefit Y includes determining if that benefit Y would be utilized by the user during the time period between T₁ and T₂.

A second time period (e.g., ending at time T₂), is rolled forward in time from the first time period, and includes the predicted label Y_{T1} of the benefit Y, between time T₁ and time T₂. In some embodiments, similar to the first time period, the second time period is coextensive with the length of the time window (e.g., three months, two months, or another length of time). In some embodiments, the second time period may be a portion of the length of a time window (e.g., the second time period is one month within a three-month time window, two weeks within a three-month time window, or another length of time). Data from the second time period (e.g., including the predicted label Y_{T1}) are used to extract information about the user feature X associated with the second time period, denoted as X_{T2}. The user feature X_{T2} determined from the data associated with the second time period ending at time T₂ is used to predict a label for the benefit Y in a time period following (e.g., immediately following) time T₂ that ends at time T₃, denoted as Y_{T2}, which predicts whether the benefit Y would be utilized by the user during the time period between T₂ and T₃. The process is repeated to generate data for the machine learning model (e.g., the attention-based machine learning model 144 of FIG. 1).

A third time period (e.g., ending at time T₃), is rolled forward in time from the second time period, and includes the predicted label Y_{T2} of the benefit Y, between time T₂ and time T₃. Data from the third time period (e.g., including the predicted label Y_{T2}) are used to extract information about the user feature X associated with a third time period, denoted as X_{T3}. The user feature X_{T3} determined from the data associated with the third time period ending at time T₃ is used to predict a label for the benefit Y in a time period following (e.g., immediately following) time T₃ that ends at time T₄, denoted as Y_{T3}, which predicts whether the benefit Y would be utilized by the user during the time period between T₃ and T₄. A fourth time period (e.g., ending at time T5), is rolled forward in time from the third time period, and includes the predicted label Y_{T3} of the benefit Y, between time T₃ and time T₄. Data from the fourth time period (e.g., including the predicted label Y_{T3}) are used to extract information about the user feature X associated with the fourth time period, denoted as X_{T4}. The user feature X_{T4} determined from the data associated with the fourth time period ending at time T₄ is used to predict a label for the benefit Y in a time period following (e.g., immediately following) time T₄ that ends at time T₅, denoted as Y_{T4}, which predicts whether the benefit Y would be utilized by the user during the time period between T₄ and T₅.

In some embodiments, the rolling window approach 300 involves using more than four time periods (e.g., five, six, seven, or more), or fewer than four time (e.g., three or two) periods. In some embodiments, a time period Δ (hereinafter also sometimes referred to as time interval Δ) between T_{N+1} and T_{N}, where N represents the number of time periods (e.g., between T₂ and T₁, between T₃ and T₂ etc.) and is configurable. For example, the time period Δ may be set to three months, and optionally set to be equal across the time periods (e.g., for four equal time intervals Δ between T₅ and T₁, each three months long, would cover an entire year). In some embodiments, the use of a rolling window logic to generate data for the attention-based machine learning model 144 of FIG. 1 may provide a common time window for all benefits of the enrollment program, enabling the different benefits to be compared and/or ranked. In some embodiments, the use of a rolling window logic may also enable user behavior to be captured throughout the lifecycle of the enrollment program. For example, a user may have only recently joined the enrollment program and is early in the user's journey in the network environment and/or the enrollment program, so different communication elements may be selected for the user based on the length of time of usage of the enrollment program. In some embodiments, data recorded from a preceding period (e.g., one year back, or another duration) is processed, a machine learning model (e.g., the attention-based machine learning model 144 of FIG. 1) is trained at a regular time interval (e.g., every two weeks, or a different time interval), and the time window (e.g., between T_{N+1} and T_{N}) shifts forward by the regular time interval. In some embodiments, the trained machine learning model is used to make predictions (e.g., selecting a communication element) at much more frequent time intervals (e.g., every day, or a different interval shorter than the regular time interval) than the regular time interval on which the machine learning model is trained.

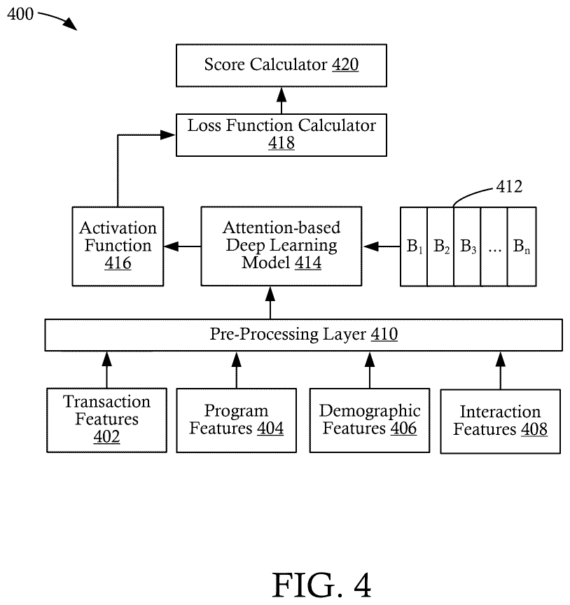

FIG. 4 is a block diagram showing an example system for selecting one or more communication elements in accordance with some embodiments. In some embodiments, a system 400 may receive, as inputs, one or more of transaction features 402, program features 404, demographic features 406 and interaction features 408. The system 400 may be implemented by a computing device, such as the communication element selection computing device 102 (e.g., by one or more of the attention-based learning models 144, the weight determinator 146, the score calculator 148) illustrated in FIG. 1.

In some embodiments, a feature generator extracts and/or generates relevant input features from an input dataset (e.g., the data records 132 of FIG. 1) to yield the transaction features 402, the program features 404, the demographic features 406 and/or the interaction features 408. For example, in some embodiments, the feature generator extracts and/or generates a plurality of user features that includes one or more of: transactional features, features associated with different categories of an enrollment program, features associated with user interaction with communication elements associated with benefits of the enrollment program, and/or demographic features.

In some embodiments, the transaction features 402 may be extracted from transaction data that includes transaction sources (e.g., web orders, in-store orders, etc.), transactions associated with a predetermined period (such as a trial period for an enrollment program, and/or data processed using the rolling window logic described with reference to FIG. 3), transactions including predetermined items and/or predetermined categories, total expenses associated with a transaction, average expenses for all transactions, a transaction interval, a transaction regularity, and/or any other transactional features. Transactional data can include historical data (e.g., data representative of prior transactional interactions with one or more systems associated with a particular retailer or service provider). In some embodiments, real-time data (e.g., data representative of a current interaction with one or more systems associated with the particular retailer or service provider) may be included.

In some embodiments, the program features 404 may be extracted from historical data of a user's usage of various benefits in the enrollment program. For example, the program features 404 may include features representative of a current state of the user identifier with respect to an enrollment program and can indicate that the user identifier is associated with a user account that has not previously enrolled in an enrollment program, a user account that has previously enrolled but is not currently enrolled in an enrollment program, or a user account that is currently enrolled in an enrollment program. For example, the program features 404 may include features indicating the number of times the benefit relating to free shipping with no minimum purchase has been used in a predetermined period, the total number of different benefits a user has utilized, and/or other historical usage data of the various benefits in the enrollment program. For example, in some embodiments, the program features 404 include features associated with different categories of an enrollment program. For example, the different categories of an enrollment program involves categories with features associated with the benefit being a cost-saving related benefit, features associated with the benefit being a first-party benefit, features associated with the benefit being a third-party benefit, features associated with the benefit being a single-use benefit, and/or features associated with the benefit being a multiple-use benefit.

The demographic features 406 can include one or more of: a user identifier, age, gender, occupation, income, vehicle ownership status, education level, and/or other information related to an individual associated with the user identifier. For example, the user identifier may contain a unique data representation associated with a user. Demographic features can be obtained from the user, for example during interactions with a user interface, and/or can be obtained from a third-party data provider. In some embodiments, demographic information is partially anonymized prior to being associated with a user profile. For example, in some embodiments, demographic features can be converted into bands or buckets that associate a user identifier with a particular segment of a population (e.g., individuals aged 18-35, individuals within a particular zip code) without providing exact identifying information for a particular user (e.g., without providing an exact age). The demographic features 406 may include features from a recency, frequency, and monitored value model (RFM) such as recency values, frequency values, monitored values (e.g., tracked monetary values), customer segment classifications, and/or any other suitable model-specific features. In some embodiments, a user identifier may be segmented into multiple customer segment classifications based on historical interaction data and/or user preference selections. In some embodiments, the demographic features may indicate the user's affinities for different interactions (e.g., automobile-related transactions to purchase related products, and/or grocery-related transactions).

The interaction features 408 can include information about items the user has viewed on the network environment, and/or how the user engages with the content items provided by the network environment (e.g., which content items were clicked by the user, which content items were closed by the user, and/or what further interactions occurred upon the user clicking on the content item). For example, in some embodiments, the interaction features 408 include features associated with user interaction with one or more communication elements.

In some embodiments, a pre-processing layer 410 receives one or more of the transaction features 402, program features 404, demographic features 406 and/or interaction features 408. In some embodiments, the pre-processing layer 410 may standardize the received features that may be derived from data sets having very different scales and units. In some embodiments, the pre-processing layer 410 may perform logarithmic scaling, categorical encoding, and feature imputations on the one or more of transaction features 402, program features 404, demographic features 406 and/or interaction features 408. In some embodiments, the pre-processing layer 410 may be implemented by the pre-processor 134 described above with respect to FIG. 1. An attention-based deep learning model 414 receives the output of the pre-processing layer 410 (e.g., processed features that are standardized, scaled, encoded with categorical data, and/or imputed with missing features). In some embodiments, the attention-based deep learning model 414 may be implemented by the attention-based learning model 144 illustrated in FIG. 1. The attention-based deep learning model 414 also receives a collection of labels 412 corresponding to a plurality of benefits of an enrollment program of the network environment. For example, FIG. 4 shows a depiction of n different benefits. In some embodiments, the label of each of the n benefits is either a “0,” denoting that a respective benefit is not used, and/or not predicted to be used, or a “1,” denoting that the respective benefit is used, and/or is predicted to be used. The output of the attention-based deep learning model 414, after receiving the processed features from the pre-processing layer 410 and the collection of labels 412, is provided to an activation function 416. In some embodiments, the activation function 416 is a sigmoid function. Other activation functions, such as hyperbolic tangent functions, rectified linear unit activation functions, may also be used. The output from the activation function 416 is provided to a loss function calculator 418. In some embodiments, the loss function calculator 418 computes a pairwise ranking loss and a score calculator 420 receives the output of the loss function calculator 418 and computes final benefit scores for each of the n benefits. For example, in some embodiments, the score calculator 420 calculates the final benefit score by incorporating values from calculations of a pairwise ranking loss for pairs of communication elements in the plurality of communication elements (e.g., computed by the loss function calculator 418), as described below in more detail.

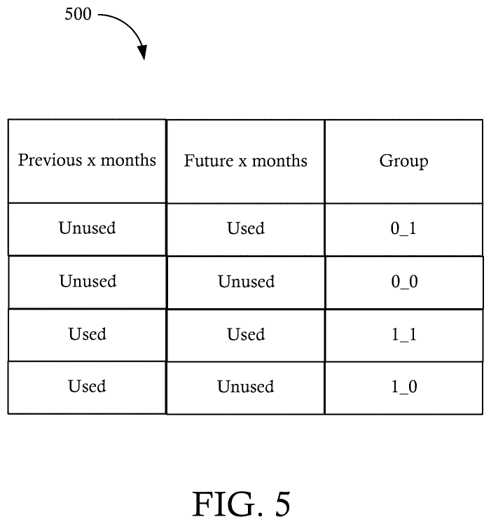

FIG. 5 is a schematic table for different example groupings of the communication elements in accordance with some embodiments. A table 500 shows different groups to which a communication element associated with a respective benefit can be assigned based on whether the respective benefit was used in a previous time period (e.g., previous X months, where X may be 3 months or a different number of months) and whether the respective benefit is predicted to be used in future time period (e.g., future X months, where X may be 3 months or a different number of months). For example, a communication element associated with a first benefit is assigned to the group “0_1” if the first benefit was not used in the previous X months but is predicted to be used in the future X months. A communication element associated with a second benefit is assigned to the group “0_0” if the second benefit was not in the previous X months but is predicted not to be used in the future X months. A communication element associated with a third benefit is assigned to the group “1_1” if the third benefit was used in the previous X months but is predicted to also be used in the future X months. A communication element associated with a fourth benefit is assigned to the group “1_0” if the fourth benefit was used in the previous X months but is predicted not to be used in the future X months. For example, the plurality of communication elements associated with respective benefits of an enrollment program is grouped into different usage classes based on usage in a first time window (e.g., in the previous X months) of a respective communication element of the plurality of communication elements and usage in a subsequent time window (e.g., in the future X months) following the first time window of the respective communication element. The attention-based machine learning model assigns one or more weights to each of the plurality of communication elements for a subsequent time period based on the plurality of user features obtained from a preceding time period (e.g., in the previous X months) within a time window (e.g., coextensive with the preceding time period) of the plurality of time windows. For example, the assignment of weights is a part of the model training for the attention-based machine learning model. During the model training, the weights provide different levels of attention to different historical user data point based on the user groupings, which are the “0_0,” “0_1,” “1_0,” and “1_1,” described above.

Some benefits of the enrollment programs are single-use benefits. For example, once a user has signed up for a benefit that relates to streaming services, or a benefit that relates enhanced services, that benefit of the enrollment program would not be used again (e.g., because the user has already signed up). In contrast, other benefits of the enrollment programs are multiple-use benefits. For example, a benefit that relates to free delivery from stores, a benefit that relates to free shipping with no minimum, and/or a benefit that relates to travel cost-savings are examples of multiple-use benefits. Based on the grouping illustrated in the table 500, a single-use benefit could be in all groups except the group “1_1.”

Returning to FIG. 4, using the group-based assignment for each benefit, the attention-based deep learning model 414 assigns dynamic weights, also known as attention scores, to each benefit (e.g., represented by a respective label) based on the user's feature representations (e.g., one or more of transaction features 402, program features 404, demographic features 406 and/or interaction features 408). In some embodiments, the use of attention scores enables the attention based deep learning model 414 to pay more attention to benefits that are more relevant to the user.

In some embodiments, the loss function calculator 418 uses the grouping illustrated in table 500 of FIG. 5 to calculate a pairwise loss function l(y, s):

$$l ( y , s ) = {\sum }_{i ∈ [ B ]} {\sum }_{j ∈ [ B ]} {w}_{j} {w}_{j} II ( {y}_{i} > {y}_{j} ) log ( 1 + exp ( - ( {s}_{i} - {s}_{j} ) ) )$$

where wᵢ and wⱼ are attention weights for benefit i and benefit j, respectively, sᵢ and sⱼ are the scores associated with the benefit i and benefit j (e.g., derived from the output of the activation function 416, and/or the attention-based deep learning model 414), respectively, and yᵢ and yⱼ are the labels associated with the benefit i and benefit j, (e.g., labels corresponding to the a collection of labels 412), respectively.

In some embodiments, the weights wᵢ and wⱼ for benefit i and benefit j may depend on the grouping illustrated in table 500 (e.g., the weights wᵢ and wⱼ are calculated at the group level illustrated in table 500), and the weight wᵢ is calculated as:

$${w}_{i} = \frac{1}{ℙ ( G ( {b}_{i} ) )}$$

where G(bᵢ) is a function that maps a benefit bᵢ to its usage group (e.g., one of the four groups in table 500). For example, the plurality of communication elements (e.g., associated with various benefits of the enrollment program) is grouped into different usage classes based on usage in a first time window of a respective communication element of the plurality of communication elements and usage in a subsequent time window following the first time window of the respective communication element (e.g., the usage groups “1_0,” “0_0,” “1_1,” and “0_1” described above).

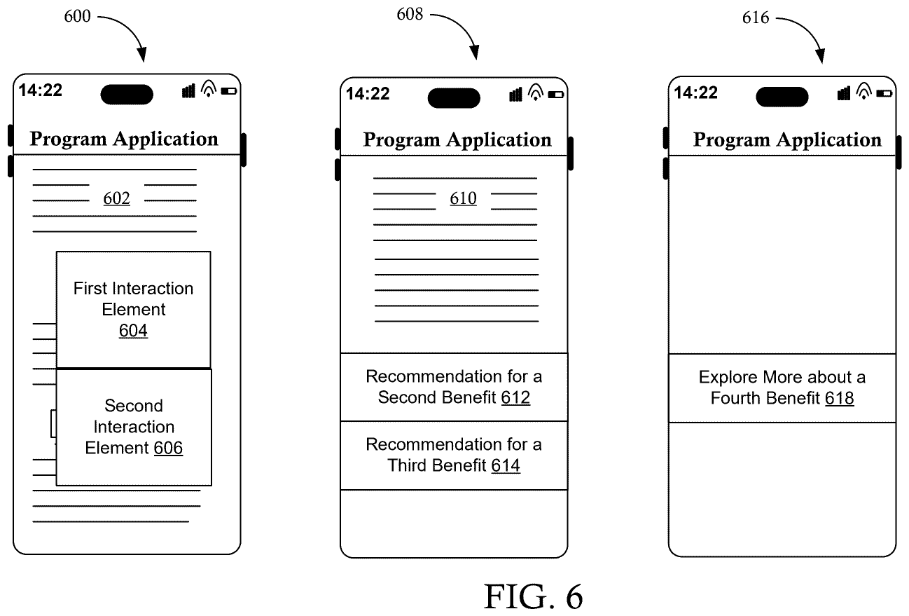

The score calculator 420 (e.g., optionally also implemented as the score calculator 148 in FIG. 1) calculates a score for each of the plurality of communication elements based on the one or more weights for each of the plurality of communication elements, taking into account the pairwise ranking loss calculated by the loss function calculator 418. In some embodiments, each score calculated by the score calculator 420 may be indicative of a probability of interaction with a corresponding communication element based on the plurality of user features. For example, the communication element associated with the highest score may correspond to a communication element of a benefit of the enrollment program that is determined by the system 400 to be relevant to the user (e.g., optionally, the most relevant to the user). When such a communication element is presented to a user, via the user interfaces illustrated in FIG. 6, for example, the user is likely to interact with the communication element by clicking on the communication element and engaging with the content presented by the communication element (e.g., signing up for a benefit of the enrollment program that the user has not yet used, learning more about one or more benefits of the enrollment program, and/or using the benefit of the enrollment program).

The system 400 may be evaluated using various metrics, such as normalized discounted cumulative gain (NDCG), mean average precision (MAP) and/or another metric. NDCG may reflect how well the ranking order generated by the system 400 (e.g., based on a ranked list of the scores calculated by the score calculator 420) compares to a ranking of the actual relevancy of the different benefits. MAP may reflect how well the system 400 determines whether a benefit identified as being relevant is actually a relevant benefit. For example, a dataset may be divided into a training dataset and a holdout dataset. The holdout dataset, which is not used to train the model, is used to evaluate the performance of the trained model. For example, the trained model (e.g., trained using the training dataset) is used to predict the data (e.g., observations or samples) in the holdout dataset. Differences between the actual data in the holdout dataset and the predictions from the trained model may be used to compute an error rate associated with the trained model, enabling the performance of the trained model to be evaluated. In some embodiments, the highest ranked benefits are in the group of “0_1,” indicating that these benefits have not been used in a preceding time period but are predicted to be used in the subsequent (e.g., immediately following) time period. Such benefits are ranked higher than benefits that are in the group of “0_0,” which are benefits that have not been used in a preceding time period and are also not predicted to be used in the subsequent (e.g., immediately following) time period.

In some embodiments, the system 400 may be able to increase a click-through rate (CTR), which is a ratio of the number of clicks on different communication elements over a total number of communication elements presented to a user, by presenting one or more of the communication elements ranked highest by the system 400 to a user. For example, an increase in the CTR may be between 4%-14% both for users who have not yet joined the enrollment program, and for users who have joined the enrollment program. Upon clicking on a respective communication element, an increase in a percentage of usage of a benefit may be between 2%-26% both for users who have not yet joined the enrollment program and for users who have joined the enrollment program. Such increases in CTR may be calculated based on A/B testing (e.g., by displaying the recommendations generated by the system 400 or not displaying the recommendations generated by the system 400). In some embodiments, improvements of benefit usage, sometimes referred to as a “relative lift,” may apply to individual benefits, such as on activation of a benefit that relates to streaming services, free shipping without a transaction minimum, and/or the usage of rewards from the enrollment project. For example, relative lifts of between 1.2%-8% may be observed for users who have not yet joined the enrollment program and relative lifts of between 0.4%-55% may be observed for users who have joined the enrollment program.

In some embodiments, the system 400 provides personalized ranking of various communication elements associated with respective benefits of an enrollment program, which may broaden the breadth of benefits used by the user (e.g., by raising awareness of various benefits associated with the enrollment program). Such a feature may be advantageous for informing users about changes in one or more benefits of the enrollment program (e.g., when benefits are added to the enrollment programs, and/or when benefits of the enrollment programs are modified) while taking into account user preferences, so that more relevant and/or appropriate benefits are recommended to the user and to increase awareness and the usage of various benefits of the enrollment program.

In some embodiments, the personalized ranking of various communication elements associated with respective benefits provided by the system 400 may increase user engagement by providing communication elements that are tailored to a user instead of recommending the same benefit to all users of the network environment.

In some embodiments, the usage of more benefits of the enrollment program may improve a likelihood of the user joining the enrollment program (e.g., the usage of four or more benefits may increase a likelihood of a user (e.g., by two times or more) joining the enrollment program compared to a user who does not use any benefit of the enrollment program). In some embodiments, a user is more likely to remain in the enrollment program (e.g., 90% chance or more) compared to a user who does not use any benefit of the enrollment program (e.g., about 50% chance of remaining in the enrollment program).

FIG. 6 depicts from example user interfaces generated by a system that implements communication element selection, in accordance with some embodiments. A first example user interface 600 includes a program application user interface 602 (e.g., an application associated with the enrollment program). In some embodiments, a first interaction element 604 and a second interaction element 606 are displayed over application content of the program application user interface 602. For example, the application content of the program application user interface 602 may include a summary of a user's usage of the enrollment program (e.g., usage statistics, total amount saved, and/or a list of available benefits). In some embodiments, the first interaction element 604 and/or the second interaction element 606 are communication elements selected by the system 400 and may include one or more recommended interaction (e.g., try free delivery, try free shipping, or another benefit) that the user may take within the enrollment program.

A second example user interface 608 includes a program application user interface 610 (e.g., an application associated with the enrollment program). In some embodiments, the application user interface 610 includes application content associated with a first benefit of the enrollment program that a user has not previously used. In some embodiments, a recommendation 612 for a second benefit of the enrollment program and/or a recommendation 614 for a third benefit of the enrollment program may be displayed concurrently with application content of the program application user interface 610. In some embodiments, the recommendation 612 for the second benefit of the enrollment program and/or the recommendation 614 for the third benefit of the enrollment program are communication elements selected by the system 400 and may include communication elements associated with one or more benefits of the enrollment program that the user has not yet started using. In some embodiments, the application user interface 610 includes application content containing a personalized list of benefits associated with the enrollment program and may be a landing page, or a hub page for the user when accessing the enrollment program.

A third example user interface 616 includes a program application user interface (e.g., an application associated with the enrollment program) that displays a communication element 618 regarding one or more benefits of the enrollment program. For example, the example user interface 616 may be a splash page that appears before a user can interact with other components of a webpage. In some embodiments, banners and/or communication elements that are presented to the user when visiting a website associated with the network environment may be personalized based on the output of the system 400. The systems and methods described herein provide a unified deep learning model that ranks a variety of heterogeneous benefits, such as first party and third-party benefits, benefits that are single-use, and benefits that are multiple-use, benefits that can be used online and benefits that can be used offline. The described systems and methods (e.g., system 400) implement a data processing framework (e.g., as implemented by communication element selector 130, to generate output such as the transaction features 402, the program features 404, demographic features 406, and/or interaction features 408) that consumes data and create features from a diverse set of data sources, which may help to capture signals for different benefits of the enrollment program. In some embodiments, the rolling window logic (e.g., the rolling window approach 300 illustrated in FIG. 3) provides a data generation process that ranks benefits in a manner that captures features from different stages of a user's usage (e.g., a user's usage lifecycle) of an enrollment program. In some embodiments, the attention loss model (e.g., as implemented as attention-based deep learning model 414 illustrated in FIG. 4, or attention-based learning model 144 illustrated in FIG. 1) may remove usage bias from the model between single-use and multiple-use benefits (e.g., by equally representing single-use benefits and multiple-use benefits).

In some embodiments, the methods and systems described herein provide an end-to-end (e.g., from data ingestion processes that generate output such as transaction features 402, program features 404, demographic features 406, and interaction features 408 to a ranked list of communication elements associated with respective benefits of an enrollment program) automated architecture that provides ranked score predictions for communication elements associated with different benefits, that is also scalable for up to millions of users of the network environment.

The task of identifying relevant communication elements associated with different benefits of an enrollment program can be burdensome and time consuming for users, especially if users are unaware of the existence of one or more benefits of the enrollment program, and/or unaware of the location within an interface suitable for engaging with an enrollment program. Typically, a user can locate information regarding an enrollment program by navigating a browse structure, sometimes referred to as a “browse tree,” in which interface pages or elements are arranged in a predetermined hierarchy. Such browse trees typically include multiple hierarchical levels, requiring users to navigate through several levels of browse nodes or pages to arrive at an interface page or communication of interest. Thus, the user frequently has to perform numerous navigational steps to arrive at a page containing information regarding enrollment programs and/or communication elements. Systems including trained attention models and trained ranking models, as disclosed herein, significantly reduce this problem, enabling users to locate communication elements of interest with fewer, or in some cases, no active steps. For example, in some embodiments described herein, when a user is presented with one or more ranked or recommended communication elements, each communication element includes, or is in the form of, a link to an interface page for engaging with an enrollment program and obtaining the benefit associated with the communication element. Each communication element and/or recommendation thus serves as a programmatically selected navigational shortcut to an interface page, enabling a user to bypass the navigational structure of the browse tree. Beneficially, programmatically identifying communication elements of interest and presenting a user with navigation shortcuts to these items can improve the speed of the user's navigation through an electronic interface, rather than requiring the user to page through multiple other pages in order to locate information about various benefits of the enrollment program and/or communication elements via the browse tree or via a search function. This can be particularly beneficial for computing devices with small screens, where fewer interface elements can be displayed to a user at a time and, thus, navigation of larger volumes of data is more difficult.

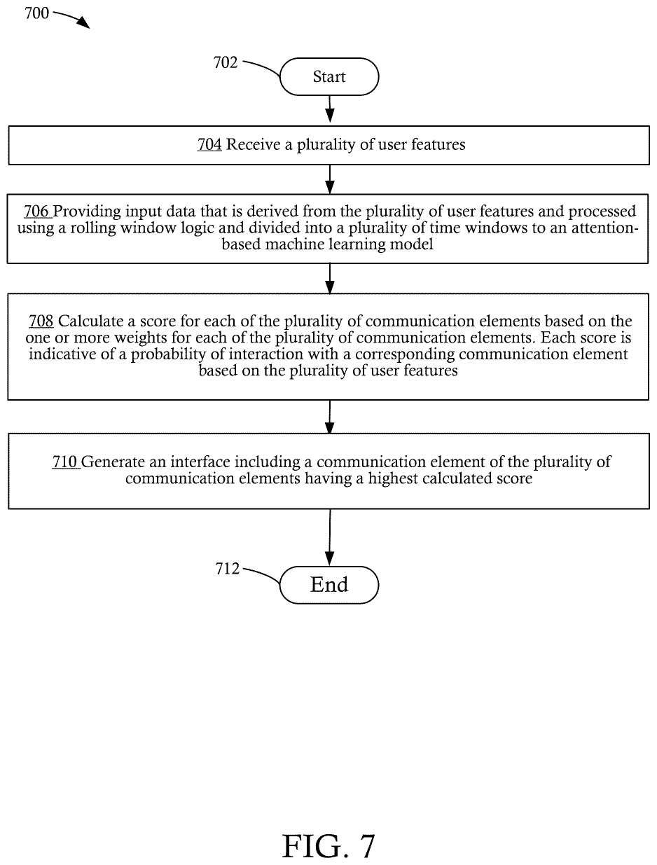

FIG. 7 is a flow diagram depicting an example method. In some embodiments, one or more blocks of the method may be executed substantially concurrently and/or in a different order than shown. In some implementations, a method may include more or fewer blocks than are shown. In some implementations, one or more of the blocks of a method may, at certain times, be ongoing and/or repeat. In some implementations, blocks of the method may be combined.

The method shown in FIG. 7 may be implemented in the form of executable instructions stored on machine-readable media and executed by a processing resource and/or in the form of electronic circuitry. For example, aspects of the methods may be described below as being performed by a communication element selection system, an example of which may be the communication element selection process 700 running on a hardware processing resource 104 of the communication element selection computing device 102 described above. Additionally, other aspects of the methods described below may be described with reference to other elements shown in FIG. 1 for non-limiting illustration purposes.

FIG. 7 depicts a flow diagram illustrating a method 700 of communication element selection, in accordance with some embodiments. Method 700 starts at block 702 and continues to block 704, where a plurality of user features may be received. At block 706, input data that is derived from the plurality of user features and processed using a rolling window logic and divided into a plurality of time windows is provided to an attention-based machine learning model.

At block 708, a score for each of the plurality of communication elements based on the one or more weights for each of the plurality of communication elements may be calculated. Each score may be indicative of a probability of interaction with a corresponding communication element based on the plurality of user features.

At block 710, an interface including a communication element of the plurality of communication elements having a highest calculated score may be generated. At block 712, the method 700 ends.

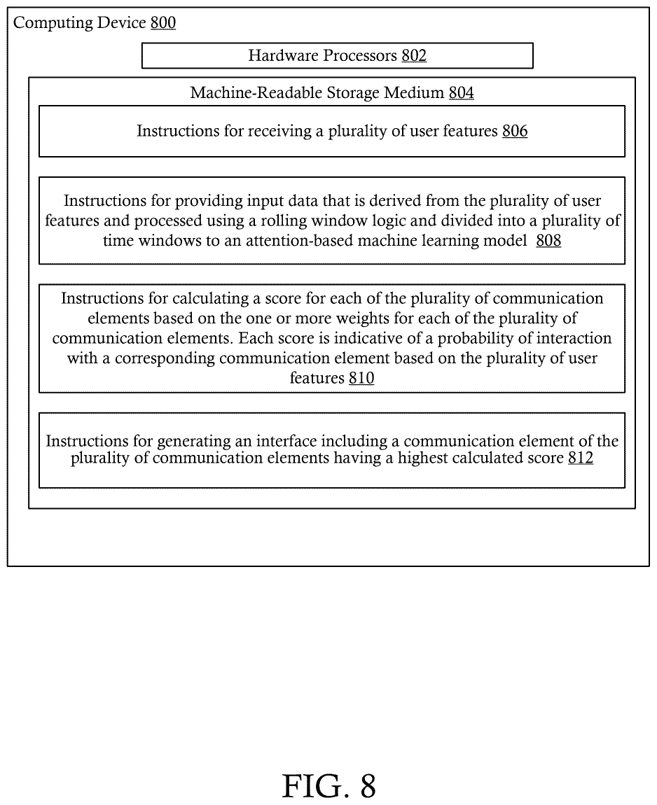

FIG. 8 depicts an example computing device 800 that includes non-transitory, machine-readable media 804 encoded with example instructions executable by processing resource 802. In some implementations, the system 800 may be useful for implementing aspects of the communication element selector 130 of FIG. 1. For example, the instructions encoded on machine-readable media 804 may be included in instructions 108 of FIG. 1. In some implementations, functionality described with respect to FIG. 1 may be included in the instructions encoded on machine-readable media 804.

The processing resource 802 may include a microcontroller, a microprocessor, central processing unit core(s), an ASIC, an FPGA, and/or other hardware device suitable for retrieval and/or execution of instructions from the machine-readable media 804 to perform functions related to various examples. Additionally, or alternatively, the processing resource 802 may include or be coupled to electronic circuitry or dedicated logic for performing some or all of the functionality of the instructions described herein.

The machine-readable media 804 may be any medium suitable for storing executable instructions, such as RAM, ROM, EEPROM, flash memory, a hard disk drive, an optical disc, or the like. In some example implementations, the machine-readable media 804 may be a tangible, non-transitory medium. The machine-readable media 804 may be disposed within the system 800 respectively, in which case the executable instructions may be deemed installed or embedded on the system. Alternatively, the machine-readable media 804 may be a portable (e.g., external) storage medium and may be part of an installation package.

As described further herein below, the machine-readable media 804 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 8.

With reference to FIG. 8, the machine-readable media 804 includes instructions 806-812. Instructions 806, when executed, cause the processing resource 802 to receive a plurality of user features. Instructions 808, when executed, cause the processing resource 802 to provide input data that is derived from the plurality of user features and processed using a rolling window logic and divided into a plurality of time windows to an attention-based machine learning model.

In accordance with a determination that the similarity score is greater than the first threshold, instructions 810, when executed, cause the processing resource 802 to calculate a score for each of the plurality of communication elements based on the one or more weights for each of the plurality of communication elements. Each score is indicative of a probability of interaction with a corresponding communication element based on the plurality of user features.

Instructions 812, when executed, cause the processing resource 802 to generate an interface including a communication element of the plurality of communication elements having a highest calculated score.

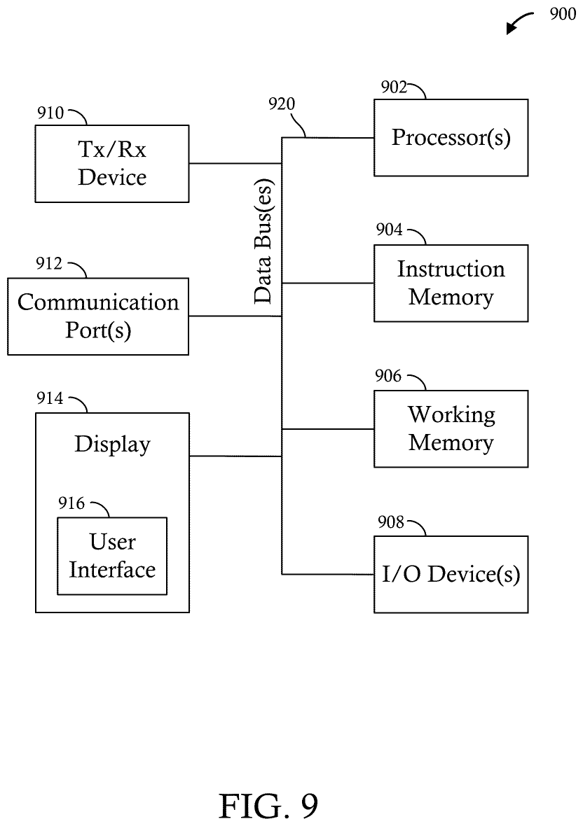

FIG. 9 illustrates a block diagram of a computing device 900, in accordance with some embodiments. Although FIG. 9 is described with respect to certain components shown therein, it will be appreciated that the elements of the computing device 900 may be combined, omitted, and/or replicated. In addition, it will be appreciated that additional elements other than those illustrated in FIG. 9 may be added to the computing device.

As shown in FIG. 9, the computing device 900 may include one or more processing resources 902, instruction memory 904, working memory 906, one or more input/output devices 908, transceiver 910, communication ports 912, display 914, and/or any other suitable elements each operatively coupled to one or more data buses 920. The data buses 920 enable communication among the various components. The data buses 920 may include wired, or wireless, communication channels.

The one or more processing resources 902 may include any processing circuitry operable to control operations of the computing device 900. In some embodiments, the one or more processing resources 902 include one or more distinct processors, each having one or more cores (e.g., processing circuits). Each of the distinct processors may have the same or different structure. The one or more processing resources 902 may include one or more central processing units (CPUs), one or more graphics processing units (GPUs), ASICs, digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 902 may also be implemented by a controller, a microcontroller, an ASIC, an FPGA, a programmable logic device (PLD), etc.

In some embodiments, the one or more processing resources 902 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 904 may store instructions that are accessed (e.g., read) and executed by at least one of the one or more processing resources 902. For example, the instruction memory 904 may be a non-transitory, computer-readable storage medium such as a ROM, an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 902 may perform a certain function or operation by executing code, stored on the instruction memory 904, embodying the function or operation. For example, one or more processing resources 902 may execute code stored in the instruction memory 904 to perform one or more of any function, method, or operation disclosed herein.

Additionally, the one or more processing resources 902 may store data to, and read data from, the working memory 906. For example, one or more processing resources 902 may store a working set of instructions to the working memory 906, such as instructions loaded from the instruction memory 904. The one or more processing resources 902 may also use the working memory 906 to store dynamic data created during one or more operations. The working memory 906 may include, for example, RAM such as a static random access memory (SRAM) or dynamic random access memory (DRAM), Double-Data-Rate DRAM (DDR-RAM), synchronous DRAM

(SDRAM), an EEPROM, flash memory (e.g. NOR and/or NAND flash memory), CAM, polymer memory (e.g., ferroelectric polymer memory), phase-change memory (e.g., ovonic memory), ferroelectric memory, SONOS memory, a removable disk, CD-ROM, any non-volatile memory, or any other suitable memory. Although embodiments are illustrated herein including separate instruction memory 904 and working memory 906, it will be appreciated that the computing device 900 may include a single memory unit that operates as both instruction memory and working memory. Further, although embodiments are discussed herein including non-volatile memory, it will be appreciated that computing device 900 may include volatile memory components in addition to at least one non-volatile memory component.

In some embodiments, the instruction memory 904 and/or the working memory 906 includes an instruction set, in the form of a file for executing various methods, such as methods for generating an interface based on location data and resource use probability, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 902.

The input/output devices 908 may include any suitable device that enables data input or output. For example, the input/output devices 908 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 910 and/or the communication port(s) 912 enable communication with a network. For example, if a communication network is a cellular network, the transceiver 910 allows communications with the cellular network. In some embodiments, the transceiver 910 is selected based on the type of the communication network the computing device 900 will be operating in. The one or more processing resources 902 are operable to receive data from, or send data to, a network, via the transceiver 910.

The communication port(s) 912 may include any suitable hardware, software, and/or combination of hardware and software that is capable of coupling the computing device 900 to one or more networks and/or additional devices. The communication port(s) 912 may be arranged to operate with any suitable technique for controlling information signals using a desired set of communications protocols, services, or operating procedures. The communication port(s) 912 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 912 enables the programming of executable instructions in instruction memory 904. In some embodiments, the communication port(s) 912 enable(s) the transfer (e.g., uploading or downloading) of data, such as machine learning model training data.

In some embodiments, the communication port(s) 912 couples the computing device 900 to a network. The network may include local area networks (LAN) as well as wide area networks (WAN) including without limitation internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 910 and/or the communication port(s) 912 utilize one or more communication protocols. Examples of wired protocols may include, but are not limited to, USB communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 902.xx series of protocols, such as IEEE 902.11a/b/g/n/ac/ag/ax/be, IEEE 902.16, IEEE 902.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 914 may be any suitable display and may display the user interface 916. The user interface 916 may enable user interaction with interface elements representative of a communication element selector 130. For example, the user interface 916 may be a user interface for an application of a network environment operator that enables a user to view and interact with the operator's website. In some embodiments, a user may interact with the user interface 916 by engaging the input/output devices 908. In some embodiments, the display 914 may be a touchscreen, where the user interface 916 is displayed on the touchscreen.

The display 914 may include a screen such as, for example, a Liquid Crystal Display (LCD) screen, a light-emitting diode (LED) screen, an organic LED (OLED) screen, a movable display, a projection, etc. In some embodiments, the display 914 may include a coder/decoder, also known as Codecs, to convert digital media data into analog signals. For example, the visual peripheral output device may include video Codecs, audio Codecs, or any other suitable type of Codec.

In some embodiments, the computing device 900 implements one or more modules or engines, each of which is constructed, programmed, configured, or otherwise adapted, to autonomously carry out a function or set of functions. A module/engine may include a component or arrangement of components implemented using hardware, such as by an ASIC or FPGA, for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices) that execute an operating system, system programs, and application programs, while also implementing the engine using multitasking, multithreading, distributed (e.g., cluster, peer-peer, cloud) processing where appropriate, or other such techniques. Accordingly, each module/engine may be realized in a variety of physically realizable configurations and should generally not be limited to any particular example implementation herein, unless such limitations are expressly called out. In addition, a module/engine may itself be composed of more than one sub-module or sub-engine, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 900 may be a computer, a workstation, a laptop, a server such as a cloud-based server, or any other suitable device. In some embodiments, the computing device 900 is a server that includes one or more processing units, such as one or more GPUs, one or more CPUs, and/or one or more processing cores. The computing device 900 may, in some embodiments, execute one or more virtual machines. In some embodiments, processing resources (e.g., capabilities) of the computing device 900 are offered as a cloud-based service (e.g., cloud computing).

Although embodiments are illustrated herein including certain systems and/or devices, it will be appreciated that additional systems, servers, storage mechanisms, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions that, when executed, cause the processor to:
receive a plurality of user features;
provide input data that is derived from the plurality of user features and processed using a rolling window logic and divided into a plurality of time windows to an attention-based machine learning model;
provide a plurality of communication elements to the attention-based machine learning model, wherein the attention-based machine learning model assigns one or more weights to each of the plurality of communication elements for a subsequent time period based on the plurality of user features obtained from a preceding time period within a time window of the plurality of time windows;
calculate a score for each of the plurality of communication elements based on the one or more weights for each of the plurality of communication elements, wherein each score is indicative of a probability of interaction with a corresponding communication element based on the plurality of user features; and
generate an interface including a communication element of the plurality of communication elements having a highest calculated score.

2. The system of claim 1, wherein the plurality of user features includes one or more of:
transactional features, features associated with different categories of an enrollment program, features associated with user interaction with the communication elements, or demographic features.

3. The system of claim 1, wherein the plurality of communication elements is grouped into different usage classes based on usage in a first time window of a respective communication element of the plurality of communication elements and usage in a subsequent time window following the first time window of the respective communication element.

4. The system of claim 1, wherein calculating the score includes calculating a pairwise ranking loss for pairs of communication elements in the plurality of communication elements.

5. The system of claim 4, wherein the pairwise ranking loss is calculated using an attention loss function that reduces usage bias due to characteristics of a program feature represented by a communication element.

6. The system of claim 1, wherein the plurality of user features obtained from the preceding time period within the time window of the plurality of time windows comprise user features associated with the time window, and the subsequent time period corresponds to a subsequent time window following the time window.

7. The system of claim 1, wherein the plurality of communication elements corresponds to different categories of an enrollment program.

8. A computer-implemented method, comprising:
receiving a plurality of user features;
providing input data that is derived from the plurality of user features and processed using a rolling window logic and divided into a plurality of time windows to an attention-based machine learning model;
providing a plurality of communication elements to the attention-based machine learning model, wherein the attention-based machine learning model assigns one or more weights to each of the plurality of communication elements for a subsequent time period based on the plurality of user features obtained from a preceding time period within a time window of the plurality of time windows;
calculating a score for each of the plurality of communication elements based on the one or more weights for each of the plurality of communication elements, wherein each score is indicative of a probability of interaction with a corresponding communication element based on the plurality of user features; and
generating an interface including a communication element of the plurality of communication elements having a highest calculated score.

9. The computer-implemented method of claim 8, wherein the plurality of user features includes one or more of: transactional features, features associated with different categories of an enrollment program, features associated with user interaction with the communication elements, or demographic features.

10. The computer-implemented method of claim 8, wherein the plurality of communication elements is grouped into different usage classes based on usage in a first time window of a respective communication element of the plurality of communication elements and usage in a subsequent time window following the first time window of the respective communication element.

11. The computer-implemented method of claim 8, wherein calculating the score includes calculating a pairwise ranking loss for pairs of communication elements in the plurality of communication elements.

12. The computer-implemented method of claim 11, wherein the pairwise ranking loss is calculated using an attention loss function that reduces usage bias due to characteristics of a program feature represented by a communication element.

13. The computer-implemented method of claim 8, wherein the plurality of user features obtained from the preceding time period within the time window of the plurality of time windows comprise user features associated with the time window, and the subsequent time period corresponds to a subsequent time window following the time window.

14. The computer-implemented method of claim 8, wherein the plurality of communication elements corresponds to different categories of an enrollment program.

15. A non-transitory computer readable medium having instructions stored thereon, wherein the instructions, when executed by at least one processor, cause at least one device to perform operations comprising:
receiving a plurality of user features;
providing input data that is derived from the plurality of user features and processed using a rolling window logic and divided into a plurality of time windows to an attention-based machine learning model;
providing a plurality of communication elements to the attention-based machine learning model, wherein the attention-based machine learning model assigns one or more weights to each of the plurality of communication elements for a subsequent time period based on the plurality of user features obtained from a preceding time period within a time window of the plurality of time windows;
calculating a score for each of the plurality of communication elements based on the one or more weights for each of the plurality of communication elements, wherein each score is indicative of a probability of interaction with a corresponding communication element based on the plurality of user features; and
generating an interface including a communication element of the plurality of communication elements having a highest calculated score.

16. The non-transitory computer readable medium of claim 15, wherein the plurality of user features includes one or more of: transactional features, features associated with different categories of an enrollment program, features associated with user interaction with the communication elements, or demographic features.

17. The non-transitory computer readable medium of claim 15, wherein the plurality of communication elements is grouped into different usage classes based on usage in a first time window of a respective communication element of the plurality of communication elements and usage in a subsequent time window following the first time window of the respective communication element.

18. The non-transitory computer readable medium of claim 15, wherein calculating the score includes calculating a pairwise ranking loss for pairs of communication elements in the plurality of communication elements.

19. The non-transitory computer readable medium of claim 15, wherein the plurality of user features obtained from the preceding time period within the time window of the plurality of time windows comprise user features associated with the time window, and the subsequent time period corresponds to a subsequent time window following the time window.

20. The non-transitory computer readable medium of claim 15, wherein the plurality of communication elements corresponds to different categories of an enrollment program.
